(19) United States
(12) Patent Application Publication
(10) Pub. No.: US 2006/0167805 A1
(43) Pub. Date: Jul. 27, 2006

(54) System and method for providing a service

(75) Inventors: Orestis Manthoulis, Sausalito, CA (US); David Lewis Kimble, Danville, CA (US); Arvind R. Mallya, Walnut Creek, CA (US); Douglas Ferrans, South Rockwood, MI (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/041,541

(22) Filed: Jan. 24, 2005

(51) Int. Cl. G06Q 99/00; H04L 9/00; H04K 1/00

(52) U.S. Cl. 705/52

(57) ABSTRACT

A system and method is provided for selecting an option for expanding a communication service into a service area. Expansion options are based on a state of the existing network, demographics, and fiber topology. A list is made of available options. Costs for each option are calculated. Expected revenue associated with each option is also calculated. Selection of an option is based in part on an expected cost and expected revenue associated with the option.

### BACKGROUND OF THE INVENTION

1. Field of the Invention

The present invention relates to system and method for providing a communication service to a customer area. In particular, the invention provides a system and method for performing a financial analysis among several options for providing a communication service in a customer area.

2. Description of the Related Art

A broadband communications network, such as DSL (Digital Subscriber Line) network provides services such as voice, data, and video from a service provider to customers within a customer area. The size of a customer area over which a service can be provided is generally determined by such factors as the capacity of the existing network equipment. Other factors for consideration are the existence of phone lines and fiber optic cable as well as the topology of the existing network in the customer area.

In order to expand a communication service within a customer area, a variety of factors are typically considered. These factors include costs to expand and the expected revenues attributable to the expansion. Establishing a service at low cost to the service provider into a customer area having many potential customers can be financially rewarding. On the other hand, expanding at a high cost into a customer area having only a few potential customers can represent a financial loss to a service provider (SP). Thus, there is a need to determine a financial cost of the many potential expansion solutions available to a service provider.

Determining costs includes knowing the status of and capacity of existing network equipment, determining the wide variety of options available for upgrading the existing network equipment and the import of demographic factors in the service area. An existing network can comprise any combination of communication links, including phone lines and fiber optic cables. If an existing network component, such as fiber optic cable, is already in place, then there may be no need to provide new equipment. An existing cable reduces the cost of establishing new service in the service area. Demographic factors are also included, such as the number of potential subscribers within a customer area, as well as the level of interest within a customer area for the service. For any given network configuration, there are a variety of available options for establishing a service. These options include upgrading old equipment, replacing old equipment with new equipment, changing technologies, etc. Even after a decision has been made to upgrade old equipment, for example, there are still multiple upgrade solutions to be considered. Moreover, since service providers generally consider expanding into many customer areas, there is generally a need for a method of prioritizing these expansion options.

### SUMMARY OF THE INVENTION

The present invention provides a method for selecting an option for expanding or providing a communication service, such as DSL service, into a service area. A plurality of options are identified for expanding the service based on a state of the existing network in the service area. Information on the existing network is stored in a network database. From this existing network information, a list can be made of available options for expanding a network. Costs for various options for upgrading the network, if desired, and for various options for building a network, if desired, can be calculated. Costs for equipment are stored in a database for this purpose. A related database stores technical specification of network equipment that can affect cost calculations. Costs are calculated for each expansion option and are displayed in a cost decision matrix by service area and option. The expected revenue associated with each option is also calculated. Selection of an option is based in part on an expected cost and expected revenue associated with the option. Selection is made by ranking options within service areas according to a financial calculation, such as the Net Present Value of the expansion option. A prioritization of service areas can be made according to an acceptable calculation, such as the Internal Rate of Return.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For a detailed understanding of the present invention, references should be made to the following detailed description of an exemplary embodiment, taken in conjunction with the accompanying drawings, in which like elements have been given like numerals.

FIG. 1. illustrates a communication network linking a central office to customers in an embodiment of the invention;

FIG. 2 illustrates a schematic representation of a system embodying the present invention;

FIG. 3 illustrates an example of an embedded network data base in one embodiment of the invention;

FIG. 4 illustrates a decision table for determining technology options in one embodiment of the invention;

FIGS. 5 and 6 illustrate an equipment cost table in one embodiment of the invention;

FIG. 7 illustrates a technical specification database used in one embodiment of the invention;

FIG. 8 illustrates a series of calculation performed in one embodiment of the invention;

FIG. 9 illustrates a cost reduction matrix for available expansion options in one embodiment of the invention; and

FIG. 10 illustrates a flow chart of functions performed in one embodiment of the invention.

### DETAILED DESCRIPTION OF THE INVENTION

In view of the above, the present invention through one or more of its various aspects and/or embodiments is presented to provide one or more advantages, such as those noted below.

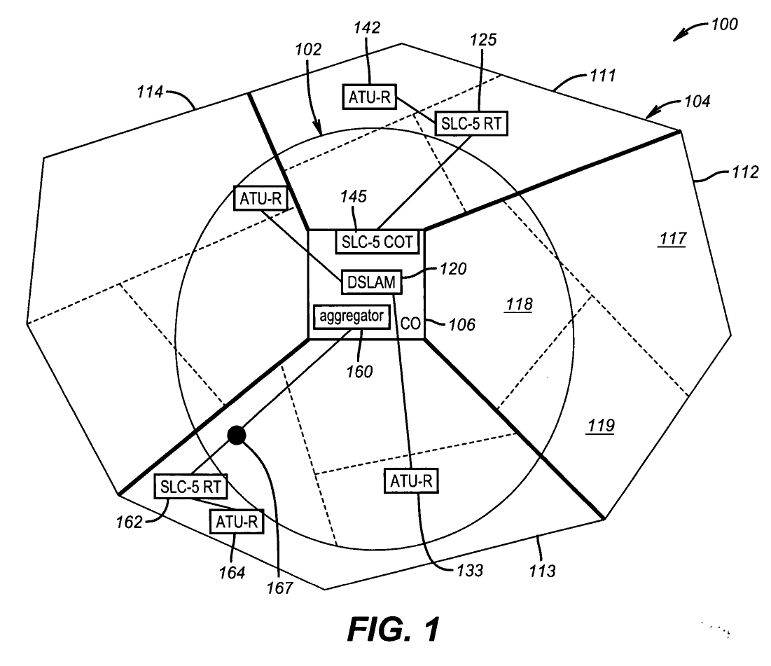

FIG. 1 illustrates an example of a communications network 100 linking a central office (CO) 106 to customers in one aspect of the present invention. The area circumscribed by contour line 104 (referred to herein as “area 104”) represents a customer area that can be serviced by the CO 106 using a variety of technologies residing at the CO. Various customers, signified by “ATU-R” (Automated Transfer Units-Remote) reside within area 104. An example of an ATU-R is an ADSL (Asynchronous DSL) modem connected to a personal computer. The area circumscribed by contour line 102 (referred to herein as “area 102”) represents a customer area that can be serviced to provide DSL service by a Digital Subscriber Line Access Multiplexer (“DSLAM”) 120 residing at the CO. A DSLAM is a mechanism at a phone company's central location that links many customer DSL connections to a single high-speed line via an ATM switch (not shown), Internet Protocol (IP) switch or router, devices responsible for directing data cells to their destination. An ADSL modem located at a personal computer sends a signal to the DSLAM when a customer establishes a link. When the phone company sends a signal, the modem uses a plain old telephone service (POTS) splitter to separate voice calls from data. The DSLAM 120 links directly to those ATU-R's, such as ATU-R 133, that reside within area 102.

A Central Office employs equipment other than DSLAM 120 to transmit service to ATU-R units located outside of area 102. A DSL Aggregator 160, for example, concentrates ATM/IP feeds from a DSLAM over a high-speed digital fiber link. The Aggregator 160 in turn connects to the broadband service provider's network over a fiber cable. Aggregator 160, for example, links to a remote terminal device 162 through repeater 167, a device for boosting a signal to extend a signal range. Remote terminal device 162 in turn links to ATU-R 164. A Subscriber Loop Carrier (SLC) is a multiplexer which enables a large number of analog lines to be provided over a very small number of digital lines. One example of an SLC is the SLC-5, of AT&T, which enables up to 192 subscriber loops to be provided over a copper wire fed T1(DS1) system with 1-4 T1(DS1) uplinks. An SLC typically comprises a Central Office Terminal (“SLC-5 COT”) and a Remote Terminal (“SLC-5 RT”). The SLC-5 COT is linked to the SLC-5 RT, which then connects to subscribers using a Voice Frequency (VF) circuit, such as a phone line. In FIG. 1, SLC-5 COT 145 links to SLC-5 RT 125, which in turn links to ATU-R 142.

Area 104 is divided into service areas, generally referred to as Distribution Serving Areas (DSAs). Four DSAs, labeled DSA#1 111, DSA#2 112, DSA#3 113, and DSA#4 114, are shown in FIG. 1. The division of area 104 into four DSAs is for illustrative purposes only, and there can be any number of DSAs within a customer area. Each DSA is further divided into Distribution Areas (DAs). In FIG. 1, for example, DSA#2 (112) is divided into DA#1 (117), DA#2 (118), and DA#3 (119). The selection of three DAs within a DSA is for illustrative purposes only, and there can be any number of DAs within a DSA.

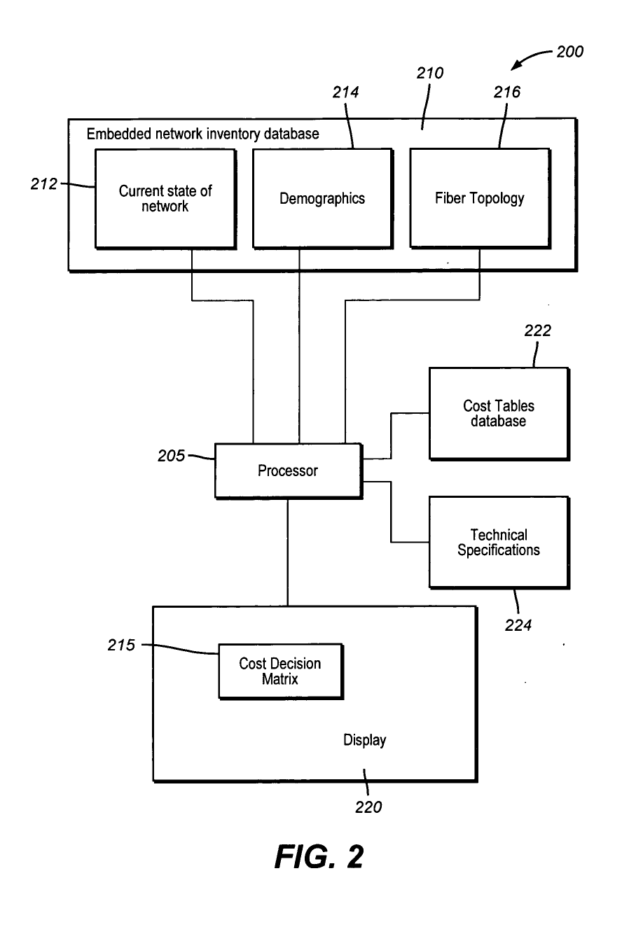

FIG. 2 illustrates an apparatus 200 in one embodiment of the present invention for selecting an option for network expansion. Processor 205 is linked to data from databases 210, 222, and 224 and determines a cost matrix 215. An embedded network inventory database 210 supplies data relating to the current state of the network. This information relates to a current network state 212, demographics 214, and fiber topology 216. Information on the current network state can be assembled from an inventory management. One example of an acceptable inventory management system would be the LFACS (Loop Facilities Assignment and Control System) provided Telcordia Technologies, which automates inventory management and assignment of subscriber access facilities for a full range of technologies, including copper-based loops, modern digital loop carrier systems, DSLAMs, and passive optical networks. The current network state 212 generally relates to parameters of an existing network, such as the amount and lengths of fiber optic cable present, the distances between network switching elements, distances between remote terminals and the central office, etc.

Database 214 provides demographic information such as, for example, an estimation of take rates (a measurement of growth of a customer base) within a customer area and a population count within a customer area. Demographic information can be obtained from census data, and other marketing databases that report cable competition and market research per neighborhood. Fiber topology database 216 describes a method of connectivity of network devices. Data related to fiber topology and fiber lengths can be obtained from a suitable inventory system, such as the Trunk Information Record Keep System (TIRKS) of Telcordia Technologies, using a suitable method of querying an inventory database.

Cost Table database 222 stores equipment costs, which are used to compute total costs of various technology expansion options, since more than one option are generally available. A technical specifications database 224 relating to network equipment is used in calculations in which specifications of network devices is a factor. Calculations performed by the processor 205 give rise to a cost decision matrix 215 shown at display 220.

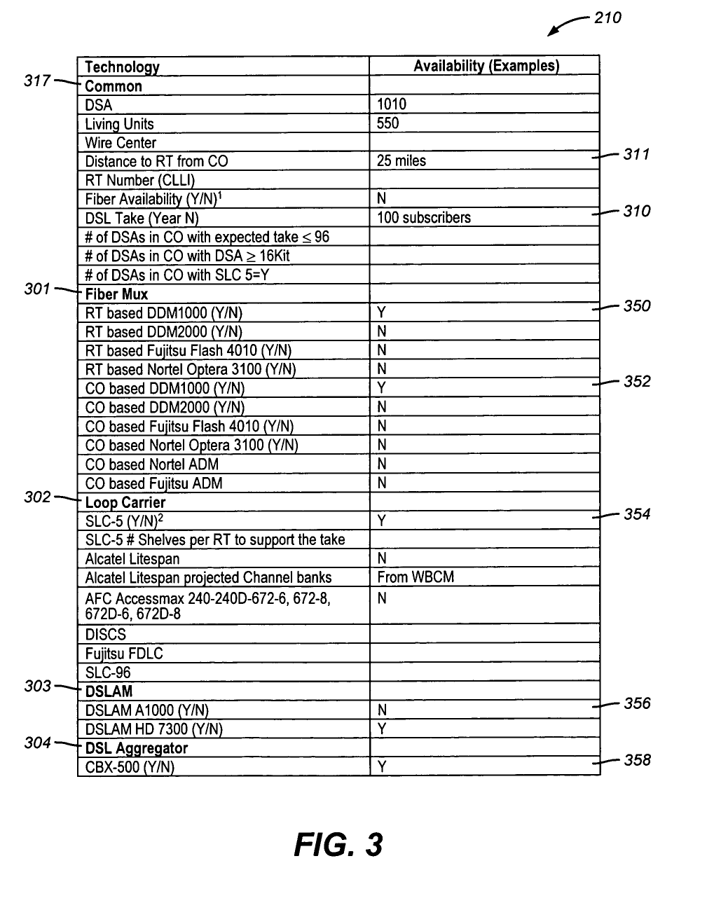

FIG. 3 illustrates an example of an embedded network information database 210 in one embodiment of the present invention. Database entries specify information relating to specific network devices (e.g. Fiber Mux 301, Loop Carrier 302, DSLAM 303, DSL Aggregator 304, etc.) detailing the present state of equipment. For instance, in the example of FIG. 3, RT based DDM1000 350, CO based DDM1000 352, SLC-5 354, DSLAM HC 7300 356, and DSL Aggregator CBX-500 358 are present in the network of the example. Common data 317 is also shown, including such demographic information, such as DSL take rate 310, and network topology information, such as distance from RT to CO 311.

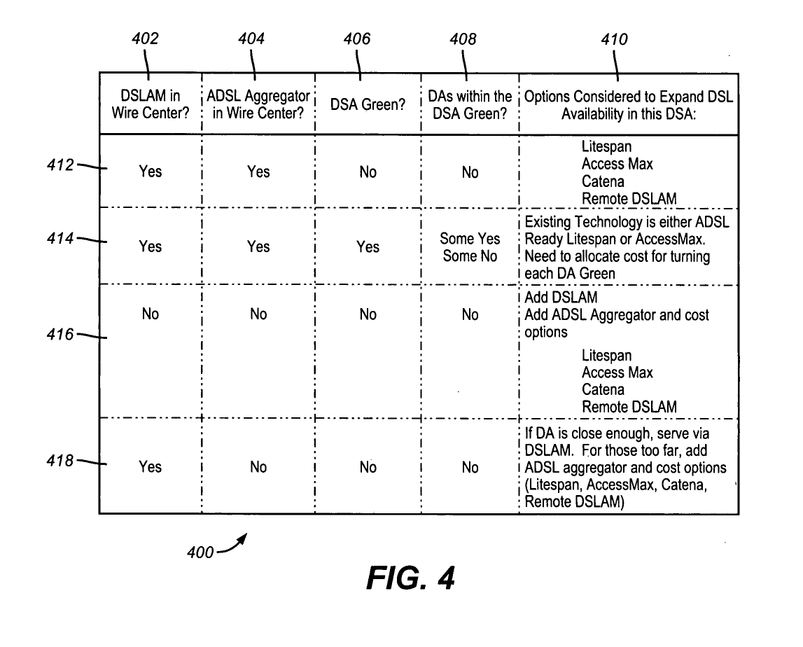

FIG. 4 illustrates a decision table 400 associated with the present invention for determining technology options for establishing a network within a DSA. Columns 402, 404, 406, and 408 display a number of conditions that affect available options. Rows 412, 414, 416, and 418 detail different network configurations, typified by the responses (yes/no) to the conditions of columns 402, 404, 406, and 408. A plurality of expansion options is generally available. For example, services can be provided to a DSA by a DSLAM, if that neighborhood is close to the CO, or by upgrading an existing remote terminal facility, or by building new remote terminal facilities. In the example of table of FIG. 4, four conditions are shown: “DSLAM in Wire Center?”, “ADSL Aggregator in Wire Center?”, “DSA Green?”, “DAs within the DSA Green?”, where a green DSA refers to a DSA being ready for transmission. The technology options shown in column 410 are determined by the responses to conditions of columns 402, 404, 406, and 408. For example, a network configuration shown in row 412 has a DA in which DSLAM and ADSL Aggregator are both in the Wire Center, but neither the DSA nor the DA is “green”. Four technology options are displayed in column 410. Information from the network inventory table of FIG. 3 can be used with the table of FIG. 4 to determine available expansion options. Although the table of FIG. 4 shows four columns, this is only for illustrative purposes, and any number of conditions can be used in the table of FIG. 4.

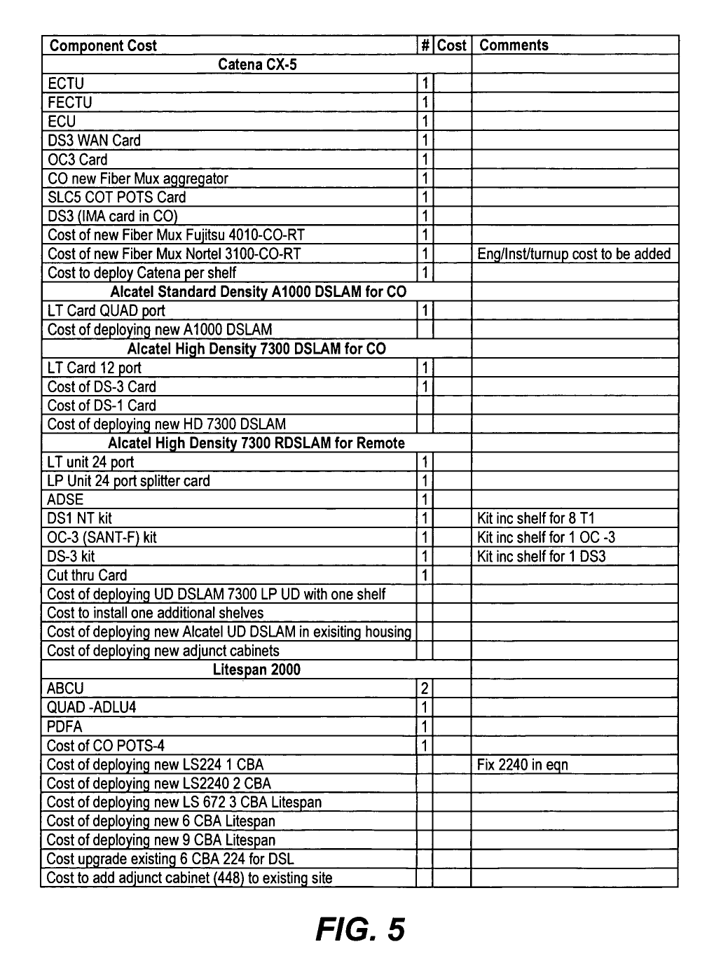

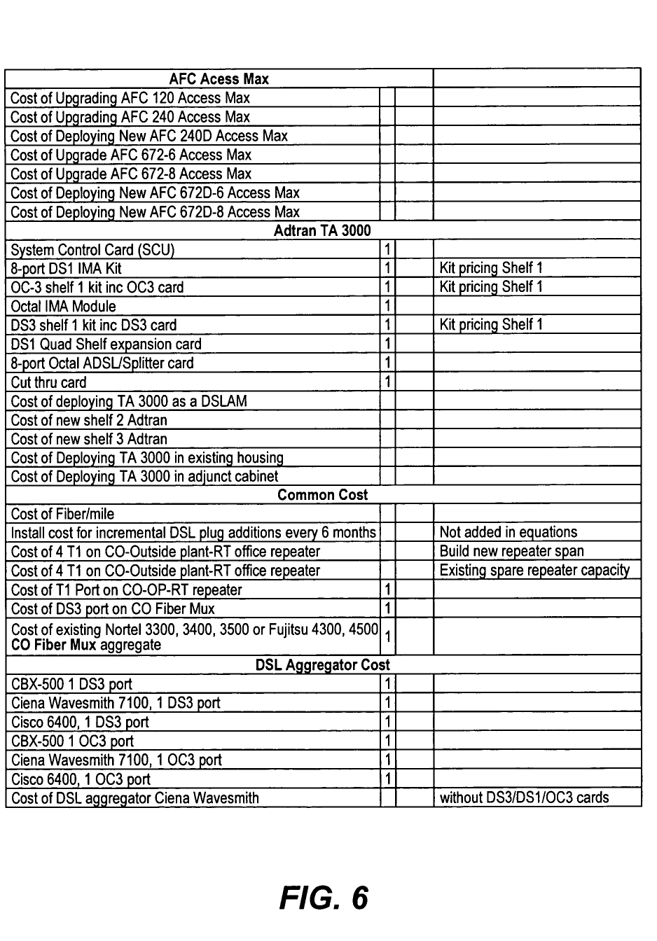

Turning now to FIGS. 5 and 6, an equipment cost table 222 associated with one aspect of the present invention illustrated beginning on FIG. 5 and continuing on FIG. 6. Costs are generally grouped by categories (i.e., 501-509) such as equipment type (which is generally determined by manufacturer). The costs shown in the cost table 222 can be used on the options stated in column 410 of FIG. 4 and overall costs of each option can be determined. Relevant information (i.e., distances, number of subscribers, etc.) can be taken from the table of FIG. 3. For instance, a cost per mile of fiber 528 can be used with the distance between RT and CO 311 from FIG. 3 to determine fiber supply costs.

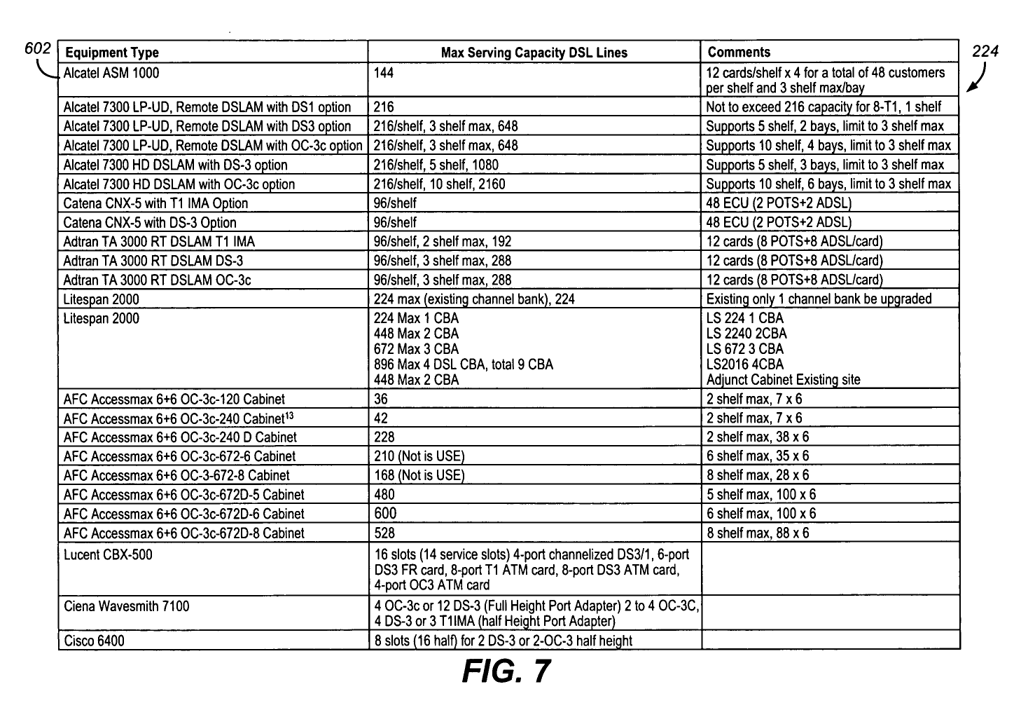

FIG. 7 illustrates a database 224 of technical specifications useful for calculating costs in one aspect of the invention. For instance, the technical capacities of a network equipment can be a factor in the number of such equipment needed, for instance, to sufficiently address the expected need of the expanded network. As an example, the Alacatel ASM 1000 (602) has a maximum serving capacity of 144 DSL lines. The cost for establishing a network in a DSA having more than 144 DSL lines is therefore affected.

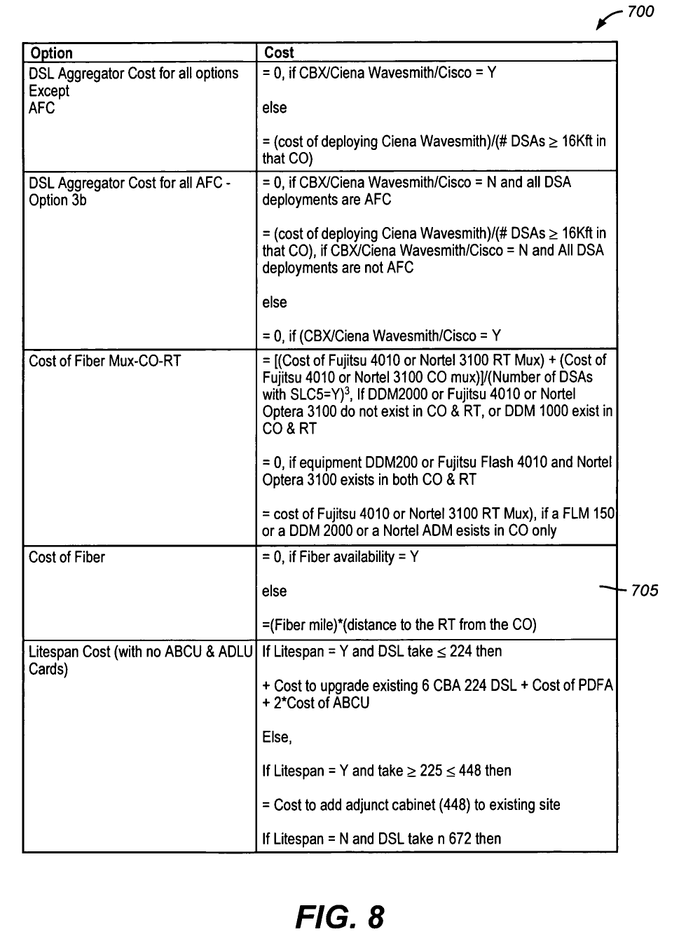

FIG. 8 illustrates a series of calculations performed by processor 205 in determining a cost of an available option in one embodiment of the present invention. Calculations generally draw upon data found in databases 212, 214, 216, 222, and 224. As an example, cost of fiber can be calculated according to the instructions 705 of FIG. 8. If fiber is currently available, the cost of new fiber is zero. (No new fiber is to be purchased.) If fiber is not currently available, the cost of laying fiber is the cost of fiber per mile multiplied by the number of miles. From the table of FIG. 3, fiber is not currently available and the distance from the RT to the CO is 25 miles. The cost of fiber per mile 528 can be found in the table 222 of FIG. 6. Thus detailed calculation 405 can be made. Calculations that use knowledge of technological considerations can be completed using data from technical specification database 224.

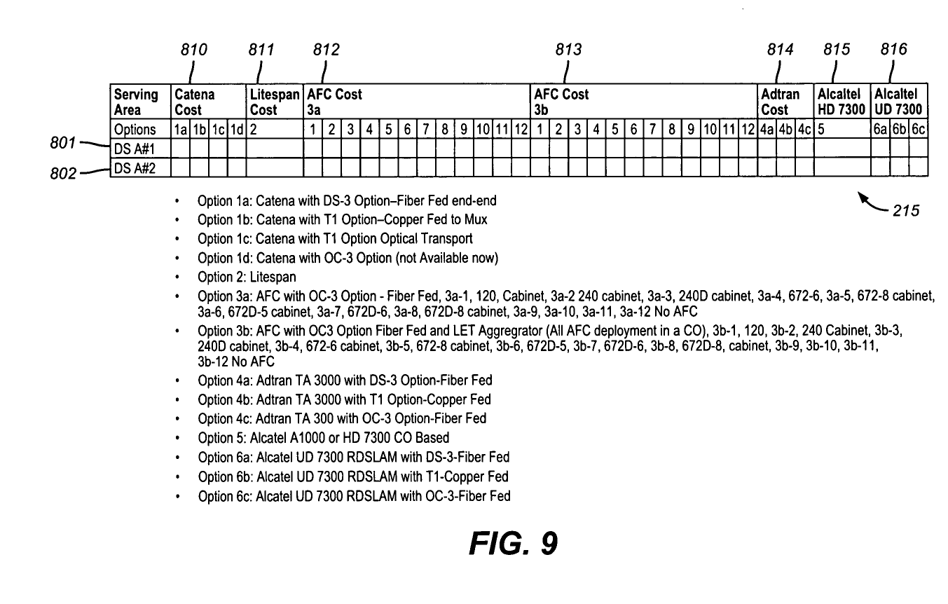

FIG. 9 illustrates a cost decision matrix associated with costs of available expansion options in one embodiment of the present invention. In the example of FIG. 9, each row (801, 802) corresponds to a DSA and each column corresponds to an available expansion option. Columns are generally grouped by technology type (810-816). Matrix entries are the calculated costs of the available options. Processor 205 prioritizes and selects options within a DSA by using an acceptable criterion, such as a calculated Net Present Value of an option. DSAs can then be ranked based on a criterion of financial return. One such method of ranking uses Internal Rate of Return. This method models first costs and subsequent monthly revenue into a cash flow present value equation.

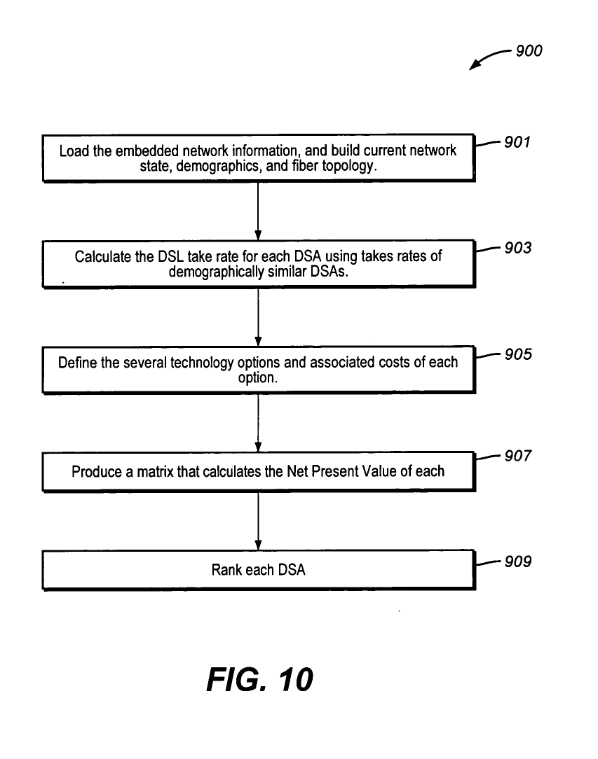

FIG. 10 illustrates a flowchart 900 of functions performed for selecting an expansion option in one aspect of the present invention. In Box 901, embedded information from database 210 about the existing network is selected using a suitable method of database query. This information is used to determine relevant factors, such as the current network state, demographics, and fiber topology.

In Box 903, a projected take rate is calculated for each DSA. Such calculations can be performed, for example, by analyzing measured take rates in DSAs where service is already available having similar demographic factors to the DSA being consider. The take rates information can be applied to the DSA being considered that has similar demographic factors. In Box 905, several technology options for expanding the network into a customer area are defined. Options are numerated using the mechanism of table 400 of FIG. 4. Costs for each numerated option are calculated using such relevant factors as the amount of equipment needed for expansion (such as determinable from database 210) and the cost per equipment (generally determined from database 222). Technical specification of network equipment, found in database 224, are used when applicable to determine costs.

In Box 907, the processor 205 produces a cost matrix whose entries are calculated costs of each option in a DSA. An expansion option per neighborhood can thereby be selected using an acceptable criteria, such as Net Present Value. Each DSA can be ranked in Box 909 based on an expected financial return. This ranking is performed according to an acceptable financial calculation. For example, in one aspect of the invention, the Internal Rate of Return (IRR) can be used to perform a ranking.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method for providing a service, comprising:
a) identifying a plurality of options for providing the service;
b) determining expected costs associated with each of the plurality of options;
c) determining expected revenue associated with each of the plurality of options; and
d) providing at least one of the plurality of options for providing the service based on the expected revenue and the expected cost associated with the at least one option.

2. The method of claim 1, wherein the service provided comprises at least one of i) a Digital Subscriber Line, and, ii) a fiber optic cable.

3. The method of claim 1, wherein the identifying the plurality of options further comprises i) identifying a state of an existing network in a customer area, ii) identifying demographics of the customer area, and, iii) identifying equipment installation options for providing the service to the customer area from the existing network.

4. The method of claim 3, wherein the state of the existing network in a customer area further comprises determining at least one of i) existence of a network in a customer area, ii) a physical structure of the network, and, ii) a level of activation of the existing network.

5. The method of claim 3, wherein the demographics of a customer area further comprises at least one of i) the number of people in the customer area, ii) a level of interest in the service.

6. The method of claim 3, wherein equipment options further comprise i) equipment options for upgrading the existing network, ii) equipment options for building a network.

7. The method of claim 1, wherein determining the expected cost further comprises determining at least one of: i),equipment costs, ii) labor costs, and, iii) projected costs of operation.

8. The method of claim 1, wherein determining the expected revenue further comprises calculating an Internal Rate of Return.

9. The method of claim 1, wherein selecting at least one option further comprises ranking the plurality of options by descending values of an Internal Rate of Return.

10. A computer readable medium containing instructions that when executed by a computer perform a method for providing a service, comprising:
a) identifying a plurality of options for providing the service;
b) determining expected costs associated with each of the plurality of options;
c) determining expected revenue associated with each of the plurality of options; and
d) providing at least one of the plurality of options for providing the service based on the expected revenue and the expected cost associated with the at least one option.

11. The medium of claim 10, wherein in the method the service provided comprises at least one of i) a Digital Subscriber Line, and, ii) a fiber optic cable.

12. The medium of claim 10, wherein in the method the identifying the plurality of options further comprises i) identifying a state of an existing network in a customer area, ii) identifying demographics of the customer area, and, iii) identifying equipment installation options for providing the service to the customer area from the existing network.

13. The medium of claim 12, wherein in the method the state of the existing network in a customer area further comprises determining at least one of i) existence of a network in a customer area, ii) a physical structure of the network, and, ii) a level of activation of the existing network.

14. The medium of claim 12, wherein in the method the demographics of a customer area further comprises at least one of i) the number of people in the customer area, ii) a level of interest in the service.

15. The medium of claim 12, wherein in the method the equipment options further comprise i) equipment options for upgrading the existing network, ii) equipment options for building a network.

16. The medium of claim 10, wherein in the method the determining the expected cost further comprises determining at least one of: i) equipment costs, ii) labor costs, and, iii) projected costs of operation.

17. The medium of claim 10, wherein determining the expected revenue further comprises calculating an Internal Rate of Return.

18. The medium of claim 10, wherein in the method the selecting at least one option further comprises ranking the plurality of options by descending values of an Internal Rate of Return.

19. A system for providing a service, comprising:
a) a database for storing cost data for the service;
b) a processor programmed to access the database and identifies a plurality of options for providing the service, determine expected costs associated with each of the plurality of options, determining expected revenue associated with each of the plurality of options and provide at least one of the plurality of options based on the expected revenue and the expected cost associated with the at least one option.

20. The system of claim 19, wherein the service provided comprises at least one of i) a Digital Subscriber Line, and, ii) a fiber optic cable.

21. The system of claim 1, wherein the processor identifies a plurality of options further comprises by identifying at least one of i) a state of an existing network in a customer area, ii) identifying demographics of the customer area, and, iii) identifying equipment installation options for providing the service to the customer area from the existing network.

22. The system of claim 21, wherein the state of the existing network in a customer area further comprises at least one of i) existence of a network in a customer area, ii) a physical structure of the network, and, ii) a level of activation of the existing network.

23. The system of claim 21, wherein the demographics of a customer area further comprises at least one of i) the number of people in the customer area, ii) a level of interest in the service.

24. The system of claim 21, wherein the equipment installation options further comprise i) equipment options for upgrading the existing network, ii) equipment options for building a network.

25. The system of claim 19, wherein determining the expected cost further comprises determining at least one of: i) equipment costs, ii) labor costs, and, iii) projected costs of operation.

26. The system of claim 19, wherein the processor determines the expected revenue further by calculating an Internal Rate of Return.

27. The system of claim 1, wherein the processor selects at least one option by ranking the plurality of options by descending values of an Internal Rate of Return.
